(19) United States
(12) Patent Application Publication
(10) Pub. No.: US 2015/0289275 A1
(43) Pub. Date: Oct. 8, 2015

(54) MOBILE STATION DEVICE AND COMMUNICATION METHOD

(71) Applicant: SHARP KABUSHIKI KAISHA, Osaka-shi, Osaka (JP)

(72) Inventors: Osamu Nakamura, Osaka-shi (JP); Shoichi Suzuki, Osaka-shi (JP); Hiroki Takahashi, Osaka-shi (JP); Jungo Goto, Osaka-shi (JP); Kazunari Yokomakura, Osaka-shi (JP); Yasuhiro Hamaguchi, Osaka-shi (JP)

(73) Assignee: SHARP KABUSHIKI KAISHA, Osaka-shi, Osaka (JP)

(21) Appl. No.: 14/426,586

(22) PCT Filed: Aug. 29, 2013
(86) PCT No.: PCT/JP2013/073111

§ 371 Date: Mar. 6, 2015

(30) Foreign Application Priority Data
Sep. 7, 2012 (JP) 2012-197588

(51) Int. Cl. H04W 72/04; H04L 5/00

(52) U.S. Cl. CPC H04W 72/0466; H04L 5/0005; H04L 5/0053; H04W 72/042

(57) ABSTRACT

A mobile station device is provided that is capable of suppressing an increase in a resource that is occupied by a PUCCH while maintaining backward compatibility in LTE. A reference signal that is spread using a spread code that has an orthogonal relationship with a spread code is arranged in a domain in which a data signal that is spread by the spread code is arranged in the PUCCH in the LTE in the related art.

### TECHNICAL FIELD

The present invention relates to a mobile station device and a communication method.

### BACKGROUND ART

According to Long Term Evolution (LTE) Release 8 (Rel-8) that specifies a wireless communication system of which standardization is under study in 3rd Generation Partnership Project (3GPP), it is possible to perform communication using a band of a maximum of 20 MHz.

Uplink (communication from a mobile station to a base station) in the LTE is configured from a Physical Uplink Shared Channel (PUSCH) for transmitting data, a Sounding Reference Signal (SRS) for understanding a channel state between the base station and the mobile station, and a Physical Uplink Control Channel (PUCCH) for transmitting control information. According to Release 8, the mobile station transmits any one of the signals described above with one piece of transmission timing.

As the control information that is transmitted on the PUCCH, there is a format 1a that transmits an ACK/NACK signal that acknowledges receipt of data which is transmitted in downlink, a format 2 that transmits a downlink channel quality indicator (CQI), or the like, and the format 1a, the format 2, and the like are specified in NPL 1.

In the format 1a, the one-bit ACK/NACK signal is modulated with Binary Phase Shift Keying (BPSK), and this is spread in a frequency domain by a sequence of which a length is 12, which results from multiplying a predetermined sequence by a cyclic shift (CS) that varies from one mobile station to another. The sequence being spread in the frequency domain is furthermore spread in a time domain by an orthogonal spread code called an orthogonal cover code (OCC) of which a length is 4, which is illustrated in FIG. 1. A signal that is obtained by the two-dimensional spread is arranged in a white-blank resource element in slots SI11 and SI12 in both ends of a system band BW that is illustrated in FIG. 2. However, in a second slot SI12, the spread is performed by a sequence different than in a first slot, and in addition, 90-degree phase rotation is performed on all signals within a slot by an index of a mobile station. Furthermore, a mobile station that is different from a mobile station which arranges the PUCCH in the slots SI11 and SI12 arranges the PUSCH in a domain D that is interposed between the slots SI11 and SI12.

On the other hand, in order to compensate for an influence of a wireless channel on the PUCCH, a Demodulation Reference Signal (DMRS) is transmitted on resource elements that are obliquely hatched in the slots SI11 and SI12 illustrated in FIG. 2, that is, on third- to fifth-line OFDM symbols in each of the slots SI11 and SI12. Additionally, a sequence used for frequency-spreading the control information in each slot is spread in terms of the time domain using an OCC (DMRS OCC) of which a length is 3, which is illustrated in FIG. 3, and thus a demodulation reference signal is obtained. At this time, an index of an OCC that is used for time-spreading the control information is the same as an index of an OCC that is used for time-spreading the demodulation reference signal.

Because 12 cyclic shifts are prepared for the PUCCH and 3 OCC's are prepared, in the format 1a, 36(12×3=36) mobile stations can share the same resource according to specifications.

Furthermore, in the format 2, by performing error correction coding on each of the CQI's of which the number is given, the CQI is set to be 20 bits, and 20 bits are set to be 10 symbols by modulating the 20 bits with QPSK. Each of the obtained 10 symbols is spread in the frequency domain by a sequence of which a length is 12, which results from multiplication by the cyclic shift (CS) that varies from one mobile station to another, and is arranged in the white-blank domain (resource element) in each of the slots SI13 and SI14 in FIG. 4.

At this point, the DMRS in the format 2 serves as specification for copying a sequence used for frequency-spreading the control information without using the OCC of which a length is 2 and for arranging the same sequence in second-line OFDM symbols and sixth-line OFDM symbols in each slot in FIG. 4, that is, a specification for performing multiplication by a code, “+1, +1” at all times.

Because the 12 cyclic shifts are prepared for the PUCCH, in the format 2, the DMRS that is transmitted by each mobile station can be demultiplexed by the cyclic shift. To be more precise, 12 mobile stations can share the same resource according to specifications. Additionally, it is disclosed in NPL 2 that orthogonality of the DMRS is improved by performing the multiplication by “+1, +1” or “+1, −1” according to notification information without multiplying the DMRS in each slot by “+1, +1” at all times.

### CITATION LIST

### Non Patent Literature

NPL 1: 3GPP, “Evolved Universal Terrestrial Radio Access (E-UTRA); Physical channels and modulation”, 3GPP, TS 36.211 V10.4.0
NPL 2: KDDI and NTT DoCoMo, “CDMA based Multiplexing of ACK/NACK and CQI Control Information in E-UTRA Uplink,” 3GPP, R1-072480, May 2007.

### SUMMARY OF INVENTION

### Technical Problem

In the LTE described in NPL 1, a specification is provided that, in a PUCCH format 1a, enables 36 mobile stations to share the same resource and that, in a PUCCH format 2, enables 12 mobile stations to share the same resource. However, in actual communication, the orthogonality of the DMRS fails by frequency selective fading due to a delay path or by time selective fading due to a movement of the mobile station. As a result, it is known that because transmission performance deteriorates, almost half as many mobile stations as can be accommodated according to specifications are difficult to accommodate. The mobile station that has difficulty in sharing the resource transmits the PUCCH using another resource. However, when the resources that are occupied by the PUCCH within a system band increase, because the resource for transmitting the PUSCH is insufficient, cell throughput decreases.

An object of the present invention, which is made in view of this situation, is to provide a mobile station device and a communication method for suppressing an increase in a resource that is occupied by a PUCCH while maintaining backward compatibility in LTE.

### Solution to Problem

(1) According to an aspect of the invention, which is made to deal with the problem described above, there is provided a mobile station device, in which, in a PUCCH in LTE Release 8, a reference signal that is spread using a spread code that has an orthogonal relationship with a spread code is arranged in a first domain in which a data signal that is spread by the spread code is arranged.

(2) Furthermore, in the embodiment of the invention, in the mobile station device according to (1), in the PUCCH in LTE Release 8, the data signal may be arranged in a second domain in which a demodulation reference signal for the data signal is arranged.

(3) Furthermore, in the embodiment of the invention, in the mobile station device according to (2), the data signal that is arranged in the second domain may be spread using the spread code, and the spread code that is used in the case where the data signal which is arranged in the second domain is spread may have the orthogonal relationship with the spread code that is used in the case where the demodulation reference signal is time-spread.

(4) Furthermore, in the embodiment of the invention, in the mobile station device according to (1), in the PUCCH in LTE Release 8, the spread codes of which the number is greater than the number of codes that are selectable as the spread code that spreads the data signal may be selectable as a code that spreads the reference signal.

(5) Furthermore, in the embodiment of the invention, in the mobile station device according to (4), in the PUCCH in LTE Release 8, the spread code that is used in the time spread of the reference signal may be selected using a value that designates a spread code which is used in frequency spread, and a value that designates a spread code that is used in time spread.

(6) Furthermore, according to another aspect of the invention, there is provided a communication method including: a first step of spreading a reference signal using a spread code that has an orthogonal relationship with a spread code that spreads a data signal in a PUCCH in LTE Release 8, and a second step of arranging the reference signal being spread in a first domain in which the data signal is arranged.

### Advantageous Effects of Invention

According to the invention, an increase in a resource that is occupied by a PUCCH can be suppressed while maintaining backward compatibility in LTE.

### BRIEF DESCRIPTION OF DRAWINGS

FIG. 1 is a diagram illustrating a correspondence between a control information OCC in a format 1a in the related art and an OCC index.

FIG. 2 is a diagram illustrating a configuration example of a frame in the format 1a in the related art.

FIG. 3 is a diagram illustrating a correspondence between a DMRS OCC in the format 1a in the related art and the OCC index.

FIG. 4 is a diagram illustrating a configuration example of a frame in a format 2 in the related art.

FIG. 5 is a schematic block diagram illustrating a configuration of a wireless communication system 10 according to a first embodiment of the present invention.

FIG. 6 is a diagram illustrating one example of a transmission frame structure in uplink according to the same embodiment.

FIG. 7 is a schematic block diagram illustrating a configuration of a mobile station device 100 according to the same embodiment.

FIG. 8 is a diagram illustrating a table that is stored by a DMRS OCC generation unit 112 according to the same embodiment.

FIG. 9 is a schematic block diagram illustrating a configuration of an OFDM signal generation unit 107 according to the same embodiment.

FIG. 10 is a schematic block diagram illustrating a configuration of a base station device 300 according to the same embodiment.

FIG. 11 is a schematic block diagram illustrating a configuration of an OFDM signal reception unit 302 according to the same embodiment.

FIG. 12 is a schematic block diagram illustrating a configuration of a mobile station device 100a according to a second embodiment of the present invention.

FIG. 13 is a diagram illustrating a combination of an OCC index and a CS value αᵤ that are allocable in LTE in the related art.

FIG. 14 is a diagram illustrating an combination of the OCC index and the CS value αᵤ that are allocable according to the second embodiment of the present embodiment.

FIG. 15 is a diagram illustrating one example of an allocation pattern of an orthogonal code of a DMRS in a case where mobile station devices that belong to 24 stations are accommodated in one resource in the related art.

FIG. 16 is a diagram illustrating one example of an allocation pattern of an orthogonal code of a DMRS according to the second embodiment of the present invention.

FIG. 17 is a graph illustrating transmission performance of a PUCCH format 1a according to the same embodiment.

FIG. 18 is a schematic block diagram illustrating one example of a configuration of a mobile station device 500 in a case where an OCC is applied to a format 2 in the related art.

FIG. 19 is a diagram illustrating the table that is stored by a DMRS OCC generation unit 511 in the related art.

FIG. 20 is a schematic block diagram illustrating one example of a configuration of a mobile station device a500 in a case where the OCC is applied to a format 2 according to a third embodiment of the present invention.

FIG. 21 is a diagram illustrating a correspondence between a DMRS OCC and a CC value according to the same embodiment.

### DESCRIPTION OF EMBODIMENTS

### First Embodiment

A first embodiment of the present invention will be described below referring to the drawing. FIG. 5 is a schematic block diagram illustrating a configuration of a wireless communication system 10 according to the first embodiment of the present invention. The wireless communication system 10 is configured to include mobile station devices 100 and 200 (also referred to as terminal devices and items of UE) that are transmitting devices according to the present embodiment, and a base station device 300 that is a receiving device according to the present embodiment. Additionally, two mobile station devices are illustrated in FIG. 5. However, one mobile device may be available, and three or more mobile station devices may be available. Each of the mobile station devices 100 and 200 is set to share the same resource and transmit Physical Uplink Control Channel (PUCCH). At this point, the resource is also referred to as a radio resource and is configured from a frequency and time. That is, the transmission with the same resource being shared is transmission at the same time through the use of the same frequency.

FIG. 6 is a diagram illustrating one example of a transmission frame structure in uplink according to the present embodiment. The structure the transmission frame according to the present embodiment in FIG. 6 is the same as a subframe structure in a PUCCH format 1a in LTE in FIG. 2 except that control information and DMRS are reversely arranged. That is, the DMRS is arranged in first-, second-, sixth-, and seventh-line OFDM symbols (first domain) in each of Slot SI1 and SI2 and a signal for control information is arranged in third- to fifth-line OFDM symbols (second domain).

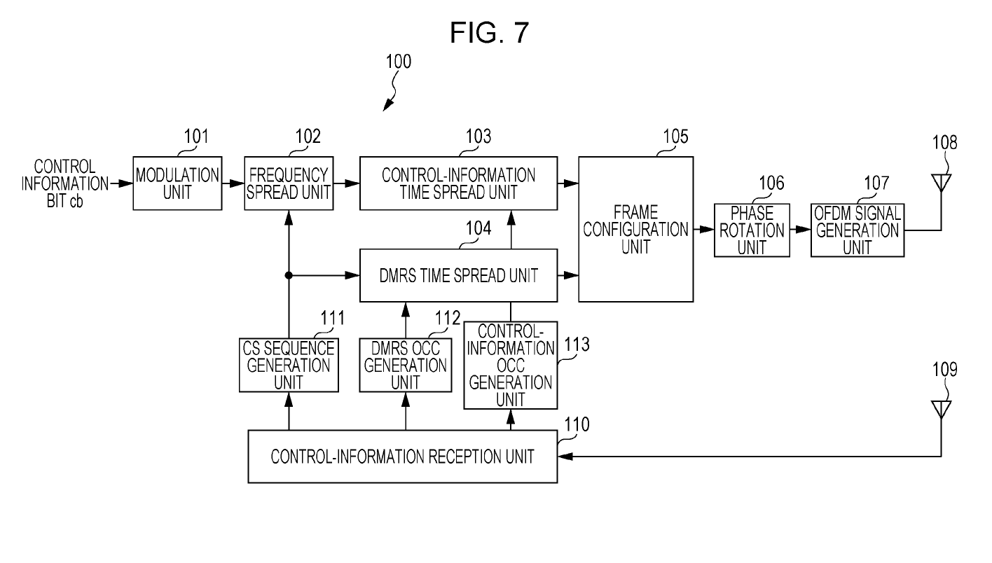

FIG. 7 is a schematic block diagram illustrating a configuration of a mobile station device 100. FIG. 7 illustrates a portion of the configuration of the mobile station device 100, which is associated with transmission of the control information in the format 1a, and illustrations of the other portions are omitted. Furthermore, because a configuration of a mobile station device 200 is the same as that of the mobile station device 100, a description of it is omitted here. The mobile station device 100 is configured to include a modulation unit 101, a frequency spread unit 102, a control-information time spread unit 103, a DMRS time spread unit 104, a frame structure unit 105, a phase rotation unit 106, an OFDM signal generation unit 107, a transmit antenna 108, a receive antenna 109, a control information reception unit 110, a CS sequence generation unit 111, a DMRS OCC generation unit 112, and a control-information OCC generation unit 113. Additionally, the number of transmit antennas in FIG. 7 is 1. However, but multiple transmit antennas may be provided, transmit diversity such as space orthogonal resource transmit diversity (SORTD) may be performed, and different pieces of control information may be transmitted from their respective transmit antenna.

Control information bit cb that is control information on a u-th mobile station device is input into the modulation unit 101. Among the pieces of control information, ACK/NACK to the downlink data is transmitted in the PUCCH format 1a. Additionally, because there is a need to transmit the ACK/NACK to each code word that transmits data, in a case where two code words are spatially-multiplexed in downlink, the control information bit cb is two bits, and in a case where only one code word is present, the control information bit cb is one bit. The modulation unit 101 performs modulation into a Binary Phase Shift Keying (BPSK) symbol, or a Quaternary Phase Shift Keying (QPSK) symbol on one-bit or two-bit control information bit cb being input, and generates a modulation symbol dᵤ (data signal) that is one symbol. The generated modulation symbol dᵤ of the u-th mobile station device is input into the frequency spread unit 102.

The frequency spread unit 102 multiplies the modulation symbol dᵤ being input by a CS sequence cᵤ(n) (0≦n≦N_{rb}−1) that is a spread code which is input from the CS sequence generation unit 111, thereby performing the spread, and generates a spread symbol sequence. At this point, N_{rb} is a width in the frequency direction, of each of the slots SI1 and SI2 in FIG. 6, that is, the number of subcarriers. 12 is used in the LTE, but N_{rb} is not limited to 12.

A receive antenna unit 109 receives a signal transmitted from the base station device 300. The signal received by the receive antenna unit 109 is input into the control information reception unit 110. The control information reception unit 110 extracts the control information that the base station device 300 transmits with the signal being input, from the signal being input. Among the pieces of extracted information, the control information reception unit 110 inputs information relating to a value αᵤ of a cyclic shift (CS) that is used for PUCCH transmission, into the CS sequence generation unit 111, inputs an OCC index for control information into the control-information OCC generation unit 113, and inputs a DMRS OCC index into the DMRS OCC generation unit 112.

The CS sequence generation unit 111 generates the CS sequence cᵤ(n) based on Equation (1) that follows.

[Math. 1]

cᵤ(n)=exp(jαᵤn)·z(n) (1)

In Equation (1), j is an imaginary unit. Because z(n) is a sequence that is determined for every base station device 300, z(n) is a sequence common to the mobile station devices 100 and 200 that share a resource. However, a sequence that varies from one slot to another is selected. Furthermore, in the u-th mobile station, αᵤ is a value for making the DMRS orthogonal in a frequency domain. The base station device 300 sets a value, as αᵤ, which varies among the mobile station devices 100 and 200, among 12 values that are determined in advance, and notifies the mobile station devices 100 and 200 of the value being set, as the control information. To be more precise, the CS sequence generation unit 111 generates a CS value αᵤ that is input from the control information reception unit 110, and generates a CS sequence from a sequence z(n) that is stored within the CS sequence generation unit 111. However, when the base station device that is connected is changed, z(n) may be updated. The CS sequence cᵤ (n) generated in the CS sequence generation unit 111 is input into the frequency spread unit 102 and the DMRS time spread unit 104.

The spread symbol sequence generated by the frequency spread unit 102 is input into the control-information time spread unit 103. The control-information time spread unit 103 performs spread to a time domain on each of the symbols that make up the spread symbol sequence being input, using an OCC for the control information that is input from the control-information OCC generation unit 113.

The OCC index for the control information is input into the control-information OCC generation unit 113 from the control information reception unit 110. The control-information OCC generation unit 113 stores an association between the OCC index for the control information and the OCC of which a length is 3. The control-information OCC generation unit 113 selects the OCC for the control information that is associated with the OCC index for the control information, referring to the stored association, and inputs the selected OCC for the control information into the control-information time spread unit 103.

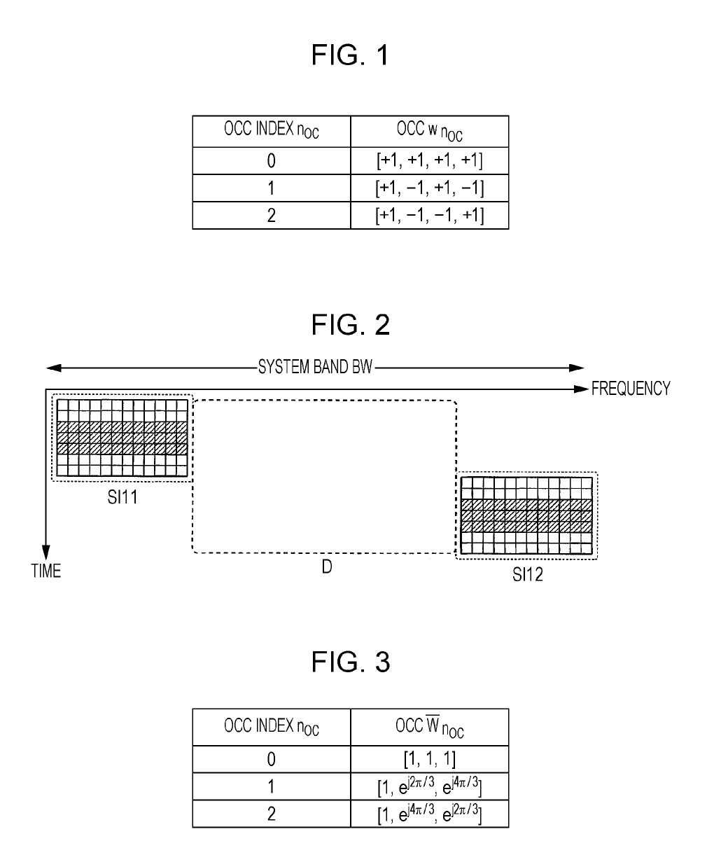

When the OCC for the control information is selected, in the LTE in the related art, because the number of symbol durations for the control information within one slot is 4 as illustrated in FIG. 2, a table that is illustrated in FIG. 1 is used. However, with the subframe structure according to the present embodiment, as illustrated in FIG. 6, because the number of symbol durations for the control information within one slot is 3, what the control-information OCC generation unit 113 stores is a table in FIG. 3, which lists associations between an OCC index and an OCC of which a length is 3. Additionally, as described above, the table in FIG. 3, is used in DMRS time spread in the LTE.

The CS sequence that is output from the CS sequence generation unit 111 is input into the DMRS time spread unit 104 as well. The DMRS time spread unit 104 performs the spread to the time domain on each of the symbols that make up the CS sequence being input from the CS sequence generation unit 11, using a DMRS OCC that is input from the DMRS OCC generation unit 112.

The DMRS OCC index is input into the DMRS OCC generation unit 112 from the control information reception unit 110. The DMRS OCC generation unit 112 stores an association between the DMRS OCC index and the OCC of which a length is 4. The DMRS OCC generation unit 112 selects the DMRS OCC that is associated with the DMRS OCC index which is input, referring to the stored association, and inputs the selected DMRS OCC into the DMRS time spread unit 104.

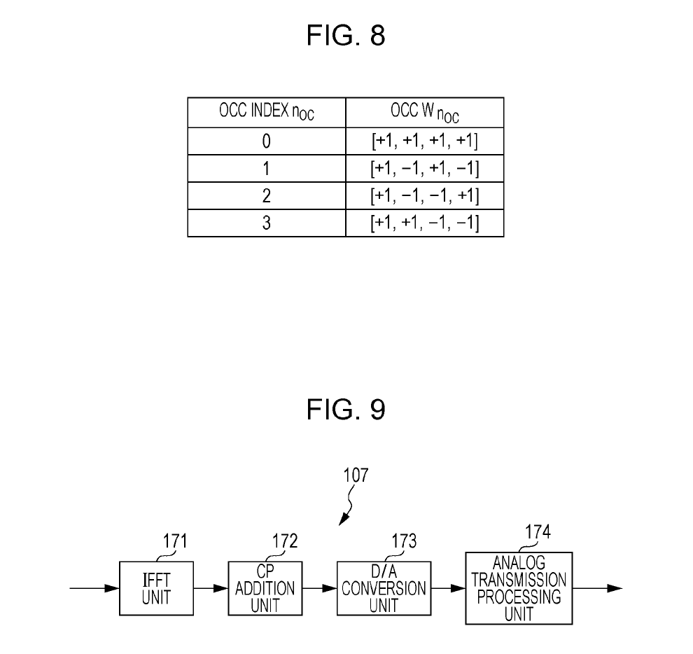

When the DMRS OCC is selected, in the LTE in the related art, because the number of DMRS symbol durations within one slot is 3 as illustrated in FIG. 2, a table that is illustrated in FIG. 3 is used. However, with the subframe structure according to the present embodiment, as illustrated in FIG. 6, because the number of DMRS symbol durations within one slot is 4, what the DMRS OCC generation unit 112 stores is a table in FIG. 8, which lists associations between the OCC index and the OCC of which a length is 4. At this point, the table in FIG. 8 is one that is obtained by adding an index 3 to the table in FIG. 1, which is used in time spread of the control information in the LTE. Because the number of indexes of the DMRS OCC in the table in the related art in FIG. 1 is 3, the index 3 is not used, but because, according to the present embodiment, the index 3 is used in order to improve orthogonality of the DMRS, the index 3 is used.

In the LTE in the related art, because the OCC's that have no orthogonal relationship with each other are applied, the control information and the DMRS are difficult to code-multiplex. However, with a frame structure according to the present embodiment and the OCC, it is possible to code-multiplex the DMRS in the LTE in the related art and the control information according to the present embodiment because, although the DMRS and the control information are arranged in the same elements, these OCC's have the orthogonal relationship with each other. In the same manner, it is possible to code-multiplex the control information in the LTE in the related art, and the DMRS according to the present embodiment as well. Additionally, there are 12 types of CS sequences as is the case with the LTE in the related art. However, because the number of the indexes of the DMRS OCC is 4, not 3 as in the LTE in the related art, the orthogonality of the DMRS can be improved.

A result of the spread by control-information time spread unit 103 and a result of the spread by the DMRS time spread unit 104 are input into the frame structure unit 105. The frame structure unit 105 configures a first slot using the result of the spread by the control-information time spread unit 103 and the result of the spread by the DMRS time spread unit 104, and arranges what is generated with the same processing as is performed for the first slot, in the second slot.

Outputs of the frame structure unit 105 (the first slot and the second slot) are input into the phase rotation unit 106. When a remainder that occurs when a value generated using an index u of the mobile station device is divided by 2 is 0, the phase rotation unit 106 performs 90-degree phase rotation on the resource element (RE) (also referred to as a subcarrier) in which the control information of the second slot is arranged. The phase rotation unit 106 outputs a signal in a frame that is made from the first slot and the second slot that is phase-rotated, into the OFDM signal generation unit 107.

The OFDM signal generation unit 107 converts the signal in the frame, which is input, into an OFDM signal, and then a result of the conversion is D/A-converted. Additionally, the OFDM signal generation unit 107 performs analog processing, such as up-conversion or power amplification, on an analog signal that is generated by the D/A conversion, and then a result of the analog processing is transmitted wirelessly from the transmit and receive antenna unit 108.

FIG. 9 is a schematic block diagram illustrating a configuration of the OFDM signal generation unit 107. The OFDM signal generation unit 107 is configured to include an Inverse Fast Fourier Transform (IFFT) unit 171, a CP addition unit 172, a D/A conversion unit 173, and an analog transmission processing unit 174.

The signal in the frame, which is output by the phase rotation unit 106, is output into the IFFT unit 171. With the number of points that is set to target an entire system band, the IFFT unit 171 performs Inverse Fast Fourier Transform on the signal in the frame, which is input. For example, when the system band is made from 2048 subcarriers, the Inverse Fast Fourier Transform is performed with 2048 points. Additionally, in a case of performing oversampling, the Inverse Fast Fourier Transform may be performed with the number (for example, 4096) of points that is obtained by multiplying the number of subcarriers by a fixed number. A result of the conversion by the IFFT unit 171 is input into the CP addition unit 172.

The cyclic prefix (CP) addition unit 172 performs processing that copies one portion of the rear of a wave form of an OFDM unit to the OFDM symbol unit and adds a copy to the front of the OFDM symbol, on a result of the conversion by the IFFT unit 161, and generates the OFDM. The copy of the one portion of the rear of the waveform, which is added to the front of the OFDM symbol, is referred to as the cyclic prefix (CP). By adding the CP, an influence of a delay wave on a channel can be suppressed. The D/A conversion unit 173 performs the D/A (digital-to-analog) conversion on the OFDM signal generated by the CP addition unit 172, and converts the OFDM signal into an analog signal. The analog transmission processing unit 174 performs the analog processing, such as analog filtering, the power amplification, and the up-conversion, on the analog signal that results from the conversion by the D/A conversion unit 163.

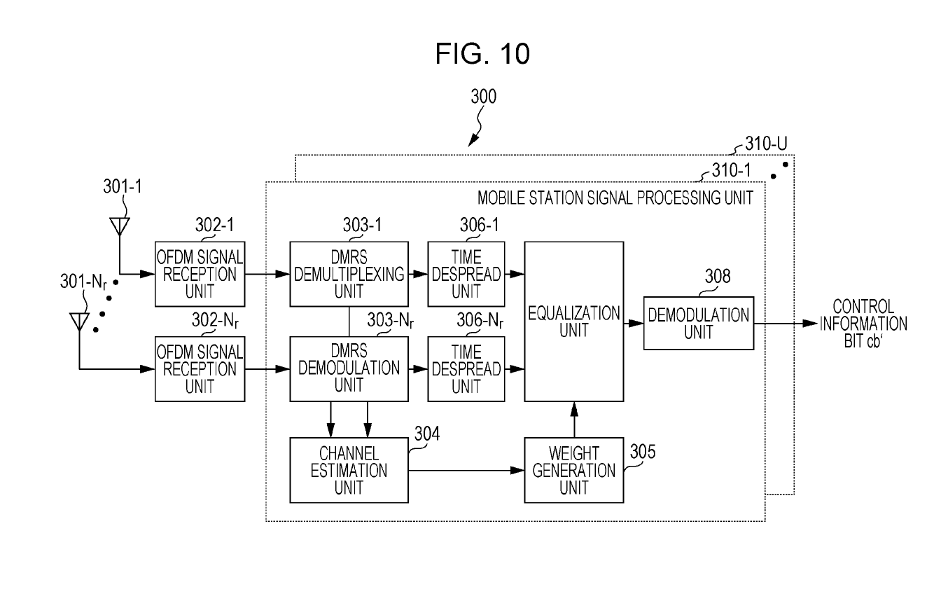

Signals transmitted from the transmit antennas 107 of the mobile station devices 100 and 200 are received in Nᵣ reception antennas of the base station device 300 through a wireless channel. FIG. 10 is a schematic block diagram illustrating a configuration of the base station device 300 according to the present embodiment. FIG. 10 illustrates a portion of the configuration of the base station device 300, which is associated with reception of the control information in the format 1a, and illustrations of the other portions are omitted. The base station device 300 is configured to include Nᵣ receive antennas 301-1 to 301-Nᵣ, Nᵣ OFDM reception units 302-1 to 302-Nᵣ, and U mobile station signal processing units 310-1 to 310-U. U mobile station signal processing units 310-1 to 310-U each are configured to include Nᵣ DMRS demultiplexing units 303-1 to 303-Nᵣ, a channel estimation unit 304, a weight generation unit 305, Nᵣ time despread units 306-1 to 306-Nᵣ, an equalization unit 307, and a demodulation unit 308. Additionally, the mobile station signal processing units 310-1 to 310-U each perform processing that detects a control information bit transmitted by a specific mobile station device.

A signal received by each of the receive antennas 301-1 to 301-Nᵣ is input into an OFDM signal reception unit that has a corresponding branch number, among the OFDM signal reception units 302-1 to 302-Nᵣ. The OFDM signal reception units 302-1 to 302-Nᵣ each down-convert the signal being input, into a baseband frequency, and then perform A/D conversion and CP removal. The OFDM signal reception units 302-1 to 302-Nᵣ each input results of these processing tasks into the mobile station signal processing units 310-1 to 310-U. In each of the mobile station signal processing units 310-1 to 310-U, the result of the processing by each of the OFDM signal reception units 302-1 to 302-Nᵣ is input into a DMRS demultiplexing unit that has a corresponding branch number, among the DMRS demultiplexing units 303-1 to 303-Nᵣ.

The DMRS demultiplexing units 303-1 to 303-Nᵣ each demultiplex the signal being input from the OFDM signal reception unit that has the corresponding branch number, among the OFDM signal reception units 302-1 to 302-Nᵣ, into a received DMRS and a received control signal. At this point, the DMRS demultiplexing units 303-1 to 303-Nᵣ each demultiplex a signal in a domain in which the DMRS is arranged, as the received DMRS, in a frame structure that is used by a transmission source of the control information which is a detection target. In the same manner, in the frame structure, the signal in the domain in which the control information is arranged is demultiplexed as the received control signal. The DMRS demultiplexing units 303-1 to 303-Nᵣ each input the received DMRS that results from the demultiplexing, into the channel estimation unit 304, and inputs the received control signal into a time despread unit that has a corresponding branch number, among the time despread units 306-1 to 306-Nᵣ.

Additionally, if transmission sources are the mobile station devices 100 and 200, because the devices use the frame structure that is illustrated in FIG. 6, the DMRS demultiplexing units 303-1 to 303-Nᵣ perform demultiplexing into the received DMRS and the received control signal according to the frame structure that is illustrated in FIG. 6. Furthermore, if the transmission sources are mobile station devices in compliance with the LTE in the related art, because the devices use the frame structure that is illustrated in FIG. 2, the DMRS demultiplexing units 303-1 to 303-Nᵣ perform the demultiplexing into the received DMRS and the received control signal according to the frame structure that is illustrated in FIG. 2.

The time despread units 306-1 to 306-Nᵣ each perform reverse processing of the time spread by the control-information time spread unit 103 in FIG. 7 on the received control signal being input. The time despread units 306-1 to 306-Nᵣ each input a result of the reverse processing into the equalization unit 307.

The channel estimation unit 304 estimates a channel state between each of the receive antennas 301-1 to 301-Nᵣ and each transmit antenna 108 of the mobile station devices 100 and 200 using the received DMRS being input, and inputs an obtained channel estimation value into the weight generation unit 305. The weight generation unit 305 generates equalization weight using the channel estimation value being input, and inputs the generated equalization weight into the equalization unit 307. A method of calculating the equalization weight will be described below.

The equalization unit 307 multiples the signals being input from the time despread units 306-1 to 306-Nᵣ by the equalization weight generated by the weight generation unit 305, performs equalization processing, and inputs a result of the equalization processing, as the post-equalization received signal, into the demodulation unit 308. Additionally, at the same time that the equalization unit 307 performs the equalization processing, the frequency spread unit 102 in FIG. 7 also performs reverse processing of frequency spread. Based on the modulation scheme (the BPSK or the QPSK) used by the modulation unit 101 in FIG. 7, the demodulation unit 308 estimates a bit that is indicated by the post-equalization received signal and output the estimated as a transmitted control information bit cb′.

At this point, the weight generation unit 305 is described. In an n-th receive antenna 301-n after time despread, a received signal rₙ(k) on a k-th subcarrier is expressed by Equation (2) that follows.

$$\begin{matrix}[ Math . 2 ] & \\ {r}_{n} ( k ) = {\sum }_{u = 0}^{U - 1} {H}_{n , u} ( k ) {c}_{u} ( k ) {d}_{u} + {Π}_{n} ( k ) & ( 2 )\end{matrix}$$

In Equation (2), dᵤ is a modulation symbol that is generated by the modulation unit 101 (in FIG. 7) in the u-th mobile station device 100 among U mobile station devices that has the same OCC index for the control information. cᵤ(k) is a value in a k-th subcarrier in the CS sequence that is generated by the CS sequence generation unit 111 (in FIG. 7) in the u-th mobile station device 100. H_{n,u}(k) are channel performance of the k-th subcarrier between the transmit antenna 108 of the u-th mobile station device 100 and the n-th receive antenna 301-n of the base station device 300. Πₙ(k) is noise in the k-th subcarrier in the n-th receive antenna 301-n of the base station device 300. When Equation (3) is used, Equation (2) is changed like Equation (4).

$$\begin{matrix}[ Math . 3 ] & \\ \{ \begin{matrix}r = {[ \begin{matrix}{r}_{0}^{T} & {r}_{1}^{T} & … & {r}_{{N}_{r} - 1}^{T}\end{matrix} ]}^{T} \\ {r}_{n} = {[ \begin{matrix}{r}_{n} ( 0 ) & {r}_{n} ( 1 ) & … & {r}_{n} ( {N}_{rb} - 1 )\end{matrix} ]}^{T} \\ {H}_{n , u} = diag ( \begin{matrix}{H}_{n , u} ( 0 ) & {H}_{n , u} ( 1 ) & … & {H}_{n , u} ( {N}_{rb} - 1 ) )\end{matrix} \\ {H}_{u} = diag ( \begin{matrix}{H}_{0 , u} & {H}_{1 , u} & … & {H}_{{N}_{r} - 1 , u} )\end{matrix} \\ {c}_{u} = {[ \begin{matrix}{c}_{u} ( 0 ) & {c}_{u} ( 1 ) & … & {c}_{u} ( {N}_{rb} - 1 )\end{matrix} ]}^{T} \\ {C}_{u} = {[ \begin{matrix}{c}_{u}^{T} & {c}_{u}^{T} & … & {c}_{u}^{T}\end{matrix} ]}^{T} \\ Π = {[ \begin{matrix}{Π}_{0}^{T} & {Π}_{1}^{T} & … & {Π}_{{N}_{r} - 1}^{T}\end{matrix} ]}^{T} \\ {Π}_{n} = {[ \begin{matrix}{Π}_{n} ( 0 ) & {Π}_{n} ( 1 ) & … & {Π}_{n} ( {N}_{rb} - 1 )\end{matrix} ]}^{T}\end{matrix} & ( 3 ) \\ r = {\sum }_{u = 0}^{U - 1} {H}_{u} {C}_{u} {d}_{u} + Π & ( 4 )\end{matrix}$$

Additionally, when Equation (5) is input, Equation (4) can be changed like Equation (6) that follows.

$$\begin{matrix}[ Math . 4 ] & \\ \{ \begin{matrix}\tilde{H} = {[ \begin{matrix}{\tilde{H}}_{0} & {\tilde{H}}_{1} & … & {\tilde{H}}_{U - 1}\end{matrix} ]}^{T} \\ d = {[ \begin{matrix}{d}_{0} & {d}_{1} & … & {d}_{U - 1}\end{matrix} ]}^{T}\end{matrix} & ( 5 ) \\ \begin{matrix}r = {\sum }_{u = 0}^{U - 1} {\tilde{H}}_{u} {d}_{u} + Π \\ = \tilde{H} d + Π\end{matrix} & ( 6 )\end{matrix}$$

When a MIMO channel in U transmit antennas and NᵣN_{rb} receive antennas is considered, the same MMSE weight as in the related art can be obtained from Equation (6). Therefore, the weight is given in Equation (7) that follows.

[Math. 5]

w=\tilde{H}^{H}(\tilde{H}\tilde{H}^{H}÷σ²I_{N}_{ᵣ}_{N}_{_{rb}})⁻¹ (7)

In Equation (7), I_{NrNrb} is an NᵣN_{rb}×NᵣN_{rb} identity matrix. Because there is a need for an NᵣN_{rb}×NᵣN_{rb} reverse matrix operation in Equation (7), a circuit scale is enlarged. For example, in a case where Nᵣ=2, and N_{rb}=12, there is a need for a 24×24 reverse matrix operation. Furthermore, according to the present embodiment, because it is considered only that the frequency spread and the antenna diversity are performed on the signal, the NᵣN_{rb}×NᵣN_{rb} reverse matrix operation is available, but the signal is actually received in a state of being spread over 3 or 4 OFDM symbols and over two slots. Then, a mathematical expression is expanded and thus it is also possible to perform an 8 NᵣN_{rb}×8 NᵣN_{rb} reverse matrix operation, but an amount of calculation is enormous. Then, it is considered that the amount of calculation is reduced by a reverse matrix lemma. When Equation (8) is given by the reverse matrix lemma, Equation (9) holds true.

[Math. 6]

X=A+BD⁻¹C (8)

X⁻¹=A⁻¹−A⁻¹B(D+CA⁻¹B)⁻¹CA⁻¹ (9)

At this point, when Equation (10) is input, Equation (7) can be changed like Equation (11) that follows.

$$\begin{matrix} [ Math . 7 ] & \\ \{ \begin{matrix}A = {σ}^{2} {I}_{{N}_{r} {N}_{rb}} \\ B = \tilde{H} \\ C = {\tilde{H}}^{H} \\ {D}^{- 1} = {I}_{U}\end{matrix} & ( 10 ) \\ \begin{matrix}w = {\tilde{H}}^{H} ( \frac{1}{{σ}^{2}} {I}_{{N}_{r} {N}_{rb}} - \frac{1}{{σ}^{2}} {I}_{{N}_{r} {N}_{rb}} {\tilde{H} ( {I}_{U} + {\tilde{H}}^{H} \frac{1}{{σ}^{2}} I \tilde{H} Δ )}^{- 1} {\tilde{H}}^{H} \frac{1}{{σ}^{2}} {I}_{{N}_{r} {N}_{rb}} ) \\ = \frac{1}{{σ}^{2}} ( {\tilde{H}}^{H} - {\tilde{H}}^{H} {\tilde{H} ( {\tilde{H}}^{H} \tilde{H} + {σ}^{2} {I}_{U} )}^{- 1} {\tilde{H}}^{H} ) \\ = \frac{1}{{σ}^{2}} ( I - {\tilde{H}}^{H} {\tilde{H} ( {\tilde{H}}^{H} \tilde{H} + {σ}^{2} {I}_{U} )}^{- 1} ) {\tilde{H}}^{H}\end{matrix} & ( 11 )\end{matrix}$$

Additionally, when Equation (12) is input, Equation (11) can be changed like Equation (13) that follows.

$$\begin{matrix}[ Math . 8 ] & \\ P = {\tilde{H}}^{H} \tilde{H} + {σ}^{2} {I}_{U} & ( 12 ) \\ \begin{matrix}w = \frac{1}{{σ}^{2}} ( {PP}^{- 1} - {\tilde{H}}^{H} \tilde{H} {P}^{- 1} ) {\tilde{H}}^{H} \\ = \frac{1}{{σ}^{2}} ( P - {\tilde{H}}^{H} \tilde{H} ) {P}^{- 1} {\tilde{H}}^{H}\end{matrix} & ( 13 )\end{matrix}$$

Additionally, Equation (14) is derived from Equation (12), and Equation (15) can be obtained by substituting Equation (14) into Equation (13). The weight generation unit 305 calculates weight w by Equation (15).

$$\begin{matrix}[ Math . 9 ] & \\ P = {\tilde{H}}^{H} \tilde{H} = {σ}^{2} {I}_{U} & ( 14 ) \\ \begin{matrix}w = {P}^{- 1} {\tilde{H}}^{H} \\ = {( {\tilde{H}}^{H} \tilde{H} + {σ}^{2} {I}_{U} )}^{- 1} {\tilde{H}}^{H}\end{matrix} & ( 15 )\end{matrix}$$

A reverse matrix operation may be performed on U lines×U columns by using Equation (15). Normally, because the number of the mobile station devices that share the OCC index for one piece of control information is at most approximately 6, an amount of calculation can be greatly reduced from a 24×24 reverse matrix operation to a 6×6 reverse matrix operation.

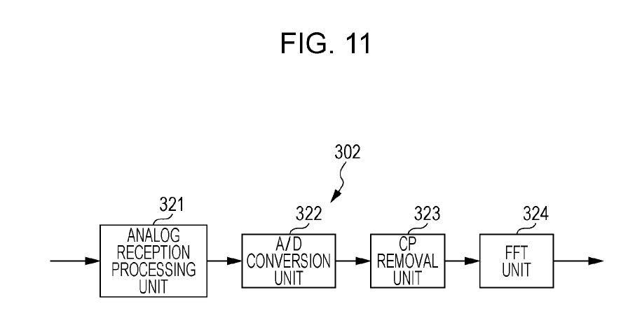

FIG. 11 is a schematic block diagram illustrating a configuration of an OFDM signal reception unit 302. OFDM signal reception units 302-1 to 302-Nᵣ have the same configuration. At this point, the OFDM signal reception unit 302, which represents these, is described. The OFDM signal reception unit 302 is configured to include an analog reception processing unit 321, an A/D conversion unit 322, a CP removal unit 323, and an FFT unit 324.

The analog reception processing unit 321 performs analog processing, such as down-conversion, analog filtering, and auto gain control (AGC), on the signal being input into the OFDM signal reception unit 302. A signal that results from the processing by the analog reception processing unit 321 is input into the A/D conversion unit 322. The A/D conversion unit 322 performs analog-to-digital (A/D) conversion on the signal being input, and thus converts the signal into a digital signal. The A/D conversion unit 322 inputs the digital signal that results from the conversion, into the CP removal unit 323.

The CP removal unit 323 removes a CP added at the transmitting side from the digital signal being input. The CP removal unit 323 inputs the signal from which the CP is removed, into the FFT unit 324. The FFT unit 324 performs Fast Fourier Transform (FFT) on the signal being input from the CP removal unit 323, and performs conversion from the signal in the time domain to the signal in the frequency domain. The FFT unit 324 inputs the signal in the frequency domain, which results from the conversion, as an output of the OFDM signal reception unit 302, into a corresponding DMRS demultiplexing unit, among the DMRS demultiplexing units 303-1 to 303-Nᵣ.

In this manner, according to the present embodiment, in the subframe structure of the LTE in the related art, the control information is transmitted in OFDM symbols in which the DMRS is transmitted, and the DMRS is transmitted in OFDM symbols in which the control information is transmitted. Because within one subframe in the LTE in the related art, many symbols are transmitted, for the control information rather than the DMRS, according to the present embodiment, the number of the OFDM symbols for the transmission of the DMRS is greater than the LTE in the related art.

As a result, according to the present embodiment, because the number of the indexes of the OCC that is used in the DMRS time spread is increased, the orthogonality of the DRMS between the mobile station devices is improved. The improvement of the orthogonality of the DMRS leads to betterment of characteristics of a bit error rate (BER) due to improvement of channel estimation precision due to the DMRS, more mobile station devices than in the related art can be accommodated within the same resource. Because a PUSCH band is not insufficient, cell throughput can increase by multiplexing the control signals for many of the mobile station devices into the same resource.

Furthermore, the MMSE weight is calculated for the weight at the time of the equalization, with a subcarrier receiving the spread signal as the received antenna. If the multiple receive antennas are used in the radio communication, interference of the (the number of the receive antennas—1) receive antennas can be removed. Therefore, according to the present embodiment, by regarding the subcarrier as the receive antenna, the interference of several times the subcarriers can be removed compared to when only the received antenna is simply used. As a result, in a base station in which the control signals for many of the mobile stations are received in a state being multiplexed, the interference between the mobile station devices can be sufficiently suppressed. Furthermore, for the weight, by using the reverse matrix lemma, an amount of calculation can be reduced and a size of a matrix that is a target of the reverse matrix operation can be changed.

Furthermore, because the orthogonality is present in a relation to the subframe structure in the LTE in the related art as well, although the mobile station device that is to perform the transmission using the subframe in the LTE in the related art and the mobile station devices 100 and 200 according to the present embodiment transmit the PUCCH's using the same resource, the base station device 300 can demultiplex these.

### Second Embodiment

According to the first embodiment, the number of the indexes of the OCC in the DMRS can be increased from 3 in the LTE in the related art to 4. In addition, because 12 types of CS sequences are present, 48(4×12=48) orthogonal codes can be generated. Therefore, according to specifications, the DMRS's of the 48 mobile station devices can be multiplexed into the same resource.

However, because the number of the indexes of the OCC of the control information is still 3, the number of maximum multiplexes of the control information is still 36. To be more precise, a different combination of an OCC and a CS sequence can be allocated to 24 stations out of 48 stations, but a combination of the OCC and the CS that is the same as those of mobile stations other than the remaining 24 stations is allocated to the remaining 24 stations.

Furthermore, in the LTE in the related art, a base station selects one from among 36 patterns of three OCC indexes and 12 types of CS sequences, and may notify each mobile station of the selected pattern, but when the number of the OCC indexes is 4 because expansion to 48 patterns occurs according to the first embodiment, there is a problem in that notification information to each mobile station is increased.

Then, according to the present embodiment, a method is described in which, as a result of a focus on the fact that all the combinations of the OCC and the CS in the DMRS are difficult to use when the combination of the OCC and the CS is considered in the control information, transmission performance that is better than in the system (LTE) in the related art is obtained with the same notification information as in the LTE in the related art. A wireless communication system 10a according to the present embodiment is configured to include the base station device 300, and mobile station devices 100a and 200a.

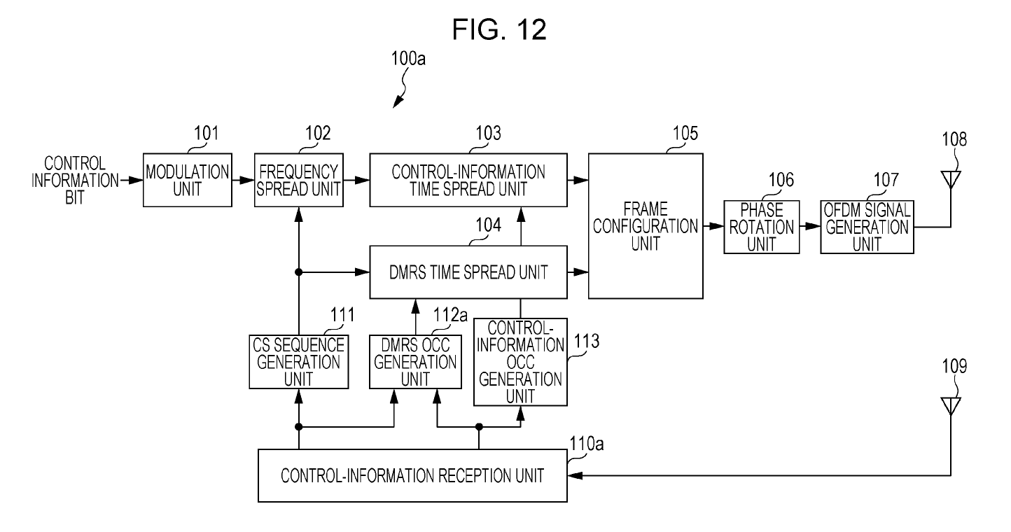

FIG. 12 is a schematic block diagram illustrating a configuration of the mobile station device 100a according to the present embodiment. FIG. 12 illustrates a portion of a configuration of the mobile station device 100a, which is associated with the transmission of the control information in the format 1a, and illustrations of the other portions are omitted. Furthermore, because a configuration of the mobile station device 200a is the same as that of the mobile station device 100a, a description of it is omitted here.

The configuration of the mobile station device 100a is almost the same as the mobile station device 100 illustrated in FIG. 7, but is different from the mobile station device 100 in that the mobile station device 100a has the DMRS OCC generation unit 112a and the control information reception unit 110a instead of the DMRS OCC generation unit 112 and the control information reception unit 110, respectively. Additionally, the OCC index that is shared for the control information and for the DMRS, and the CS value αᵤ are input into the DMRS OCC generation unit 112a from the control information reception unit 110a. Furthermore, the OCC index that is shared for the control information and for the DMRS is input into the control-information OCC generation unit 113 from the control information reception unit 110a.

According to the present embodiment, types of the CS value αᵤ and the OCC index that are notified from the base station device 300 are not different from those in the LTE system in the related art. To be more precise, an amount of notification information from the base station device 300 does not change. However, in a table that is stored in the DMRS OCC generation unit 112a, as is the case with the first embodiment, the number of the indexes is 4 as illustrated in FIG. 8. This point is described.

As described above, for an orthogonal code of the control information, 36 patterns that result from combining 12 types of CS's and 3 types of OCC's are considered, but for an orthogonal code of the DMRS, 48 patterns that result from combining the 12 types of the CS's and 4 types of OCC's are considered. Then, mobile station devices that belong to 48 stations are not accommodated in one resource, and the orthogonality for 36 stations is increased to the maximum.

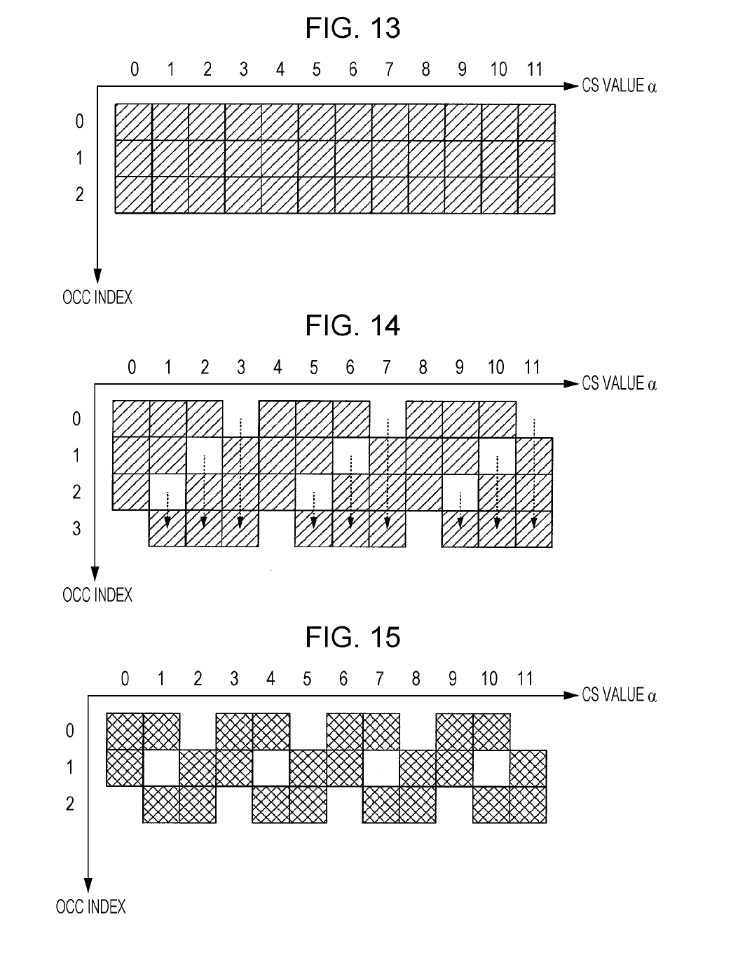

FIG. 13 is a diagram illustrating a combination of the OCC index and the CS value αᵤ that are allocable in the LTE in the related art. The combination of the orthogonal codes that are allocable is hatched. As illustrated in FIG. 13, the patterns of all the combinations are allocable in the LTE in the related art.

On the one hand, FIG. 14 is a diagram illustrating the combination of the OCC index and the CS value αᵤ that are allocable according to the present embodiment. In FIG. 14, the combination of the orthogonal codes that are allocable is hatched. As illustrated in FIG. 14, all the patterns are not allocable, and the combination that is not allocable is present. There are three types of OCC indexes from 0 to 2 that are notified from the base station device 300, but the allocation is not possible with the combination with the CS. That is, when the OCC index is 0, the CS values αᵤ that are 3, 7, and 11 are not allocable. Furthermore, when the OCC index is 1, the CS values αᵤ that are 2, 6, and 10 are not allocable. When the OCC index is 2, the CS values αᵤ that are 1, 5, and 9 are not allocable. When the OCC index is 3, the CS values αᵤ that are 0, 4, and 8 are not allocable.

In this manner, when the combination of the OCC index that is notified from the base station device 300 and the CS value αᵤ is not allocable, the DMRS OCC generation unit 112a performs allocation of the orthogonal code with the OCC index being 3. As a result, the OCC index can allocate 3 orthogonal codes without increasing the notification information from the related art.

A method of notifying the OCC index is not limited to a method in FIG. 14. For example, in the LTE, the OCC index is determined based on Equation (16) that follows.

[Math. 10]

n_{oc}^{(p)}(n)=└nₚ(nₛ)·Δ_{shift}^{PUCCH}/N′┘ (16)

In Equation (16), nₚ(nₛ) is an index of the mobile station device that is accommodated in one resource, and for example, in a case where 10 stations are accommodated, nₚ(nₛ) is a value from 0 to 9. Δ_{shift}^{PUCCH} is a value from 1 to 3, which is notified from a higher level, and is determined by the number of the mobile station devices that are accommodated within one resource. Furthermore, N′ is the number of the subcarriers within one resource.

When the method of allocating the OCC index according to the present embodiment is introduced into Equation (16), for example, Equation (16) becomes like Equation (17) that follows.

$$\begin{matrix}[ Math . 11 ] & \\ {n}_{OC}^{( p )} ( n ) = \{ \begin{matrix}3 & if {n}_{p} ( {n}_{s} ) mod 4 = 0 \\ ⌊ {n}_{p} ( {n}_{s} ) \cdot {Δ}_{shift}^{PUCCH} / {N}^{′} ⌋ & otherwise\end{matrix} & ( 17 )\end{matrix}$$

In this manner, by allocating an OCC index 3 according to the index nₚ(nₛ) of the mobile station device that is accommodated in one resource, the OCC index 3 can be allocated in the same manner as in FIG. 14, without increasing the notification information from the related art.

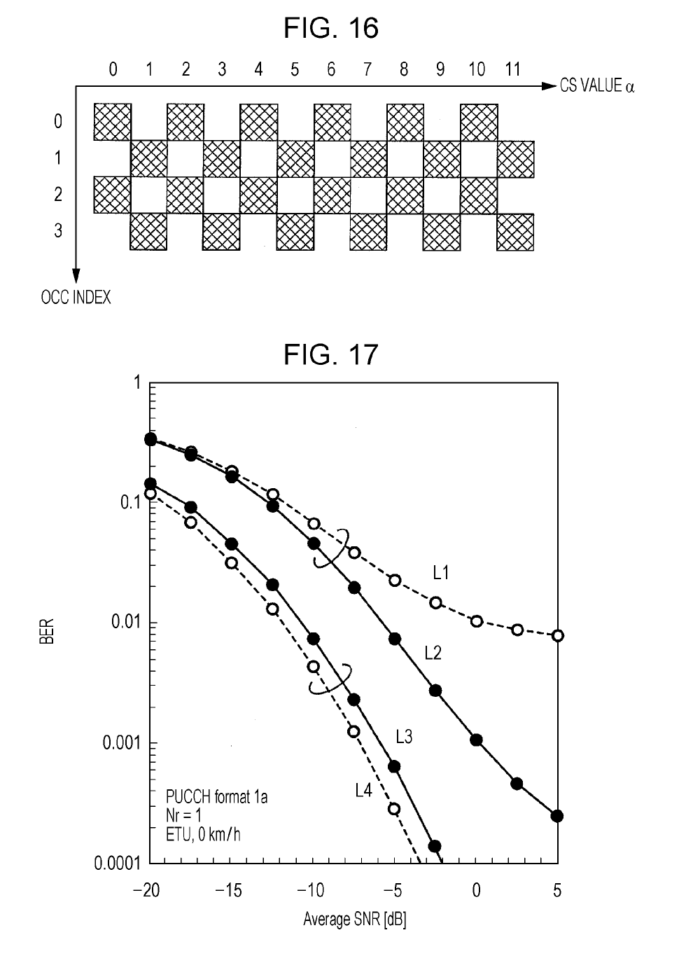

A merit according to the present embodiment will be described below. FIG. 15 illustrates one example of an allocation pattern of the orthogonal code of the DMRS in a case where the mobile station devices that belong to 24 stations are accommodated in one resource. FIG. 15 illustrates an allocation method in the LTE in the related art. In FIG. 15, there is a need to accommodate 8 mobile stations per one OCC index because only 3 types of the OCC indexes are present. As a result, an environment occurs in which an adjacent CS has to be used. On the one hand, FIG. 16 illustrates the allocation method according to the present invention. In FIG. 16, 6 mobile stations per one OCC may be accommodated because 4 types of the OCC indexes are present. As a result, because there is no need to use the consecutive CS's, the orthogonality of the DMRS is increased.

FIG. 17 is a graph that is obtained by a computer simulation, and illustrates transmission performance of the PUCCH format 1a in a case where the mobile station devices that belong to 24 stations are accommodated in one resource. A bandwidth is 10 MHz, the number Nᵣ of the receive antennas is 1, a channel model is enhance typical urban, a speed of the mobile station is 0 km/h, an equalizer uses linear weight in Equation (15), and MMSE channel estimation is used as a channel estimation method. A vertical axis indicates a bit error rate (BER) and a horizontal axis indicates a signal-to-noise power ratio (SNR). Dotted lines L1 and L4 illustrate performance in a case where, with the configuration of the LTE in the related art, all the mobile station devices perform the transmission. Solid lines L2 and L3 illustrate performance in a case where, with the configuration according to the present embodiment, all the mobile station devices perform the transmission.

Additionally, L1 and L2 are obtained at the time of channel estimation, and L3 and L4 are obtained at the time of ideal channel estimation.

As illustrated in FIG. 17, if the ideal channel estimation is assumed, performance L3 according to the present embodiment deteriorates more than performance L4 in the LTE in the related art. This is because while the control information is transmitted in 4 symbols in each slot in the LTE, according to the present embodiment, power is as low as 10 log₁₀ (¾)=1.2 dB because only 3 symbols are transmitted. However, the performance is reversed at the channel estimation. This is because according to the present embodiment, high-precision channel estimation can be performed on received power of the DMRS by allocating the orthogonal code as illustrated in FIG. 14, as well as by making an improvement of 1.2 dB as opposed to a case of the control information. As a result, error ratio performance L2 better than performance L1 in the LTE in the related art is obtained.

### Third Embodiment

The method of expanding the format 1a or a format 1b in the LTE and thus increasing the orthogonality of the DMRS according to the first and second embodiments is described, but in addition, a format is prepared from the PUCCH. For example, with regard to a format 2, it is disclosed in NPL 2 that the orthogonality is improved by applying the OCC as well as the CS to the DMRS, but because there is a need to notify the OCC index, a problem occurs in that the notification information is increased more than in the LTE in the related art. Then, according to the present embodiment, a method of improving the orthogonality of the DMRS without adding the notification information from the LTE in the related art is described.

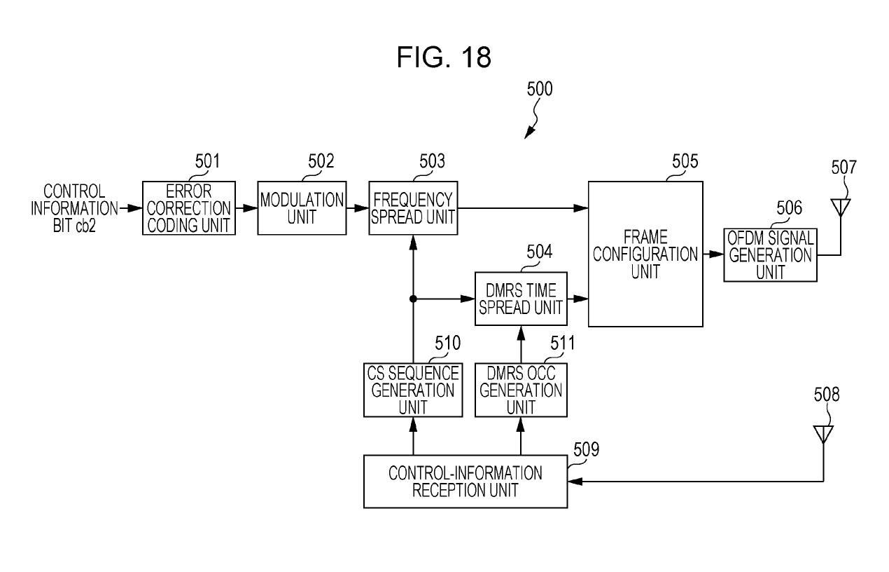

FIG. 18 is a schematic block diagram illustrating one configuration example of a mobile station device 500 in a case where the OCC is applied to the format 2, which is disclosed in NPL 2. FIG. 18 illustrates a portion of the configuration of the mobile station device 500, which is associated with transmission of the control information in the format 2, and illustrations of the other portions are omitted. An error correction coding unit 501 performs error correction coding on a control information bit cb2 that is transmitted in the format 2, and inputs an obtained coded-bit sequence into the modulation unit 502. In the LTE, a bit length of the control information bit cb2 in the format 2 is equal to or less than 11 bits, and by the error correction coding unit 501 performing the error correction coding, a 20-bit coded-bit sequence is obtained.

The modulation unit 502 performs demodulation to 10 QPSK symbols on the coded-bit sequence being input. The modulation unit 502 inputs the 10 QPSK symbols into a frequency spread unit 503. The frequency spread unit 503 multiplies each QPSK symbol being input by the CS sequence cᵤ(n) (0≦n≦N_{rb}−1) that is input from the CS sequence generation unit 510, thereby performing the spread and generates a spread symbol sequence. The CS sequence generation unit 510 is the same as that (the CS sequence generation unit 111 in FIG. 7) according to the first embodiment. The frequency spread unit 503 inputs the generated spread symbol sequence into a frame structure unit 505.

The receive antenna 508 receives a signal that is transmitted by a base station. A control information reception unit 509 extracts a CS value and an OCC index from the signal received by the receive antenna 508. The control information reception unit 509 inputs the extracted CS value into the CS sequence generation unit 510, and inputs the extracted OCC index into a DMRS OCC generation unit 511.

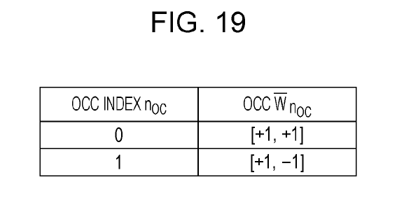

The DMRS OCC generation unit 511 stores a table that associates the OCC index and the OCC with each other. FIG. 19 is a diagram illustrating the table that is stored by the DMRS OCC generation unit 511. As illustrated in FIG. 19, the table that is stored by the DMRS OCC generation unit 511 associates an OCC index 0 and an OCC “+1, +1” with each other, and associates an OCC index 1 and an OCC “+1, −1” with each other. The DMRS OCC generation unit 511 selects the OCC that is associated with the OCC index being input, referring to the table being stored, and inputs the selected OCC into the DMRS time spread unit 504.

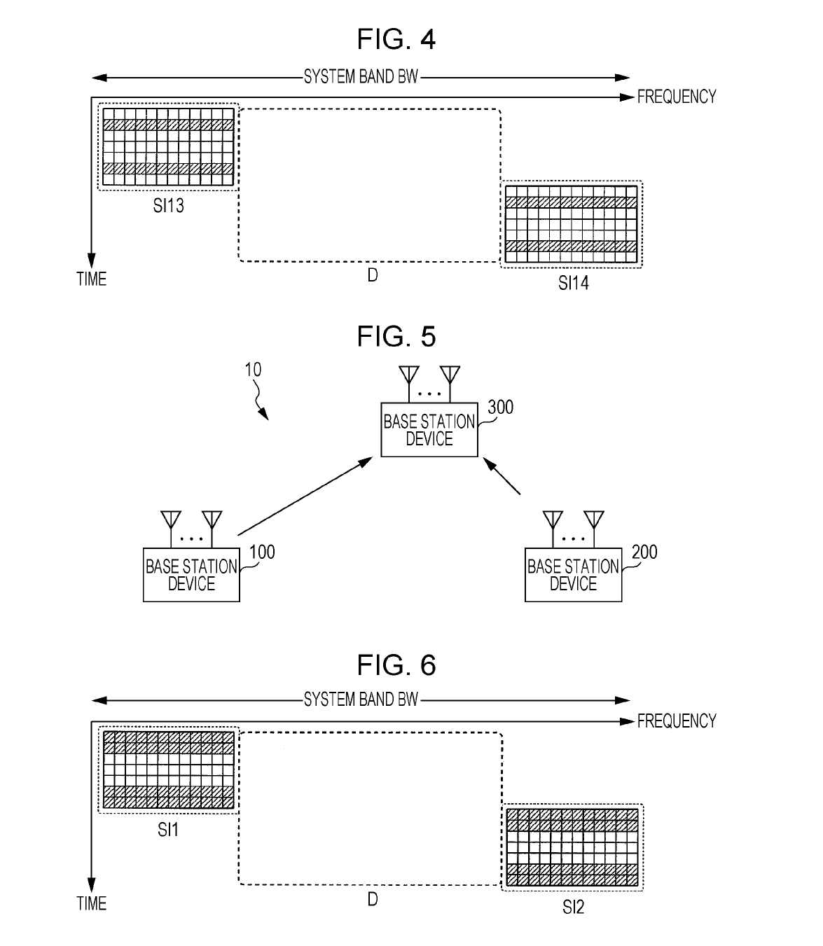

The DMRS time spread unit 504 multiplies each element that makes up the CS sequence being input from the CS sequence generation unit 510, by the OCC being input from the DMRS OCC generation unit 511, preforms the time spread, and generates a DMRS sequence. The DMRS time spread unit 504 inputs the generated DMRS sequence into the frame structure unit 505. The frame structure unit 505 arranges elements of each of the spread symbol sequence being input from the frequency spread unit 503 and the DMRS sequence being input from the DMRS time spread unit 504 according to the subframe structure illustrated in FIG. 4, and generates a frame signal. The frame structure unit 505 inputs the frame signal into an OFDM signal generation unit 506. The OFDM signal generation unit 506 generates an OFDM signal from the frame signal, and transmits the generated OFDM from the transmit antenna 507. Additionally, the OFDM signal generation unit 506 is the same as that (the OFDM signal generation unit 111 in FIG. 7) according to the first embodiment.

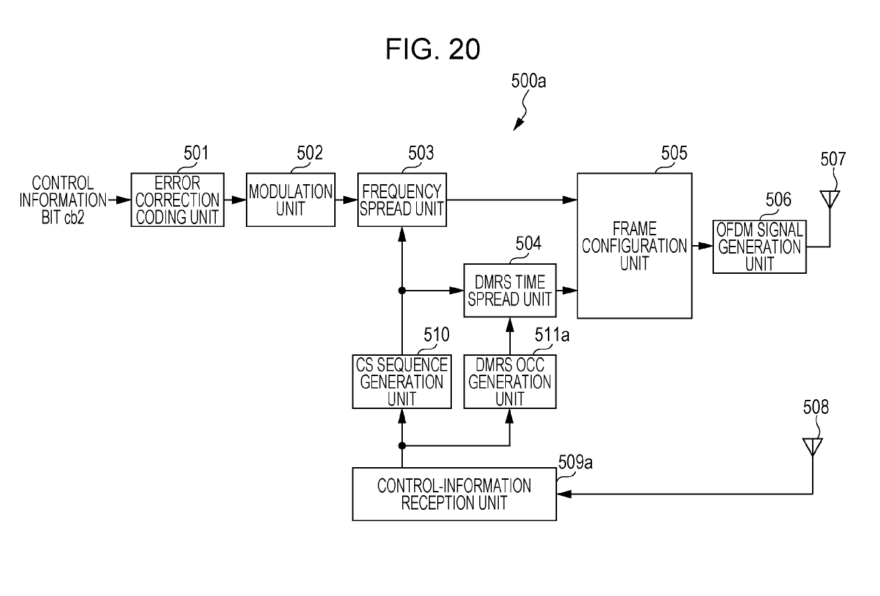

Next, a mobile station device 500a according to the present embodiment is described. FIG. 20 is a schematic block diagram illustrating one configuration example of the mobile station device 500a. The mobile station device 500a is configured to include the error correction coding unit 501, the modulation unit 502, the frequency spread unit 503, the DMRS time spread unit 504, the frame structure unit 505, the OFDM signal generation unit 506, the transmit antenna 507, the receive antenna 508, a control information reception unit 509a, the CS sequence generation unit 510, and a DMRS OCC generation unit 511a. The mobile station device 500a is different from the mobile station device 500 in FIG. 18 in that the mobile station device 500a has the control information reception unit 509a and the DMRS OCC generation unit 511a instead of the control information reception unit 509 and the DMRS OCC generation unit 511, respectively. The other components are the same as those of the mobile station device 500, and descriptions of them are omitted.

The control information reception unit 509a extracts a CS value from the received signal, and inputs the extracted CS value into the CS sequence generation unit 510 and the DMRS OCC generation unit 511a. According to the present embodiment, in the same manner as in the LTE in the related art, only information (a CS value) relating to the CS from a base station is notified and information (an OCC index) relating to the OCC is not notified.

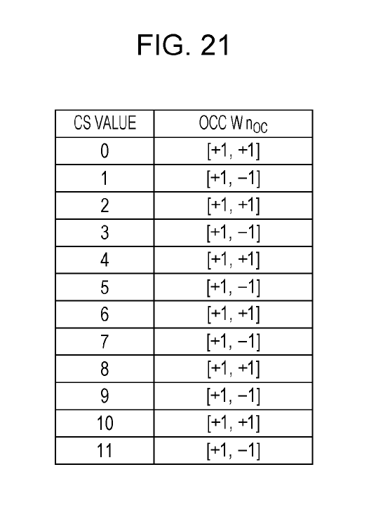

The DMRS OCC generation unit 511a stores a table that associates a CS value from 0 to 11 and an OCC with each other. FIG. 21 is a diagram illustrating an example of the table that is stored by the DMRS OCC generation unit 511a. The table associates “+1, +1” with an even-numbered CS and associates “+1, −1” to an odd-numbered CS. The DMRS OCC generation unit 511a selects the OCC that is associated with the CS value being input, referring to the stored table. The DMRS OCC generation unit 511a inputs the selected OCC into the DMRS time spread unit 504.

According to the present embodiment, when the OCC is determined, by using the table as illustrated in FIG. 21, the OCC can be applied to the DMRS without the base station notifying the information relating to the OCC such as the OCC index. As a result, the orthogonality of the DMRS can be improved. Furthermore, because the present embodiment follows the frame structure in the LTE in the related art, backward compatibility in the LTE in the related art is maintained as well. To be more precise, it is possible to share the same resource with a mobile station in the LTE in the related art. However, because in the LTE in the related art, the OCC is not applied, considering this, there is a need for a base station to perform the allocation of the CS to each mobile station.

According to the present embodiment, because a different OCC is allocated to an adjacent CS, the orthogonality of the DMRS is improved. However, because the OCC index is not notified to the mobile station as disclosed in NPL 2, in the same manner as in the LTE, the number of the mobile stations that are capable of performing the multiplexing is still the number of the CS's, that is, 12, and is not increased.

Incidentally, a format called the format 2a is present in the PUCCH. In a format 2a, in addition to the same CSI as in the format 2 being notified, one-bit ACK/NAXK can be transmitted as well along with the CSI by spreading the DMRS within the one slot using “+1, +1” or “+1, −1”. Additionally, in a format 2b, two-bit ACK/NACK can be notified to a base station along with the CSI by spreading the DMRS within one slot using any one of “+1, +1”, “+1, +j”, “+1, −1”, and “+1, −j”.

Therefore, although the OCC is individually notified as disclosed in NPL 2, multiplexing by the OCC is not possible with the format 2a or the format 2b that is spread using the same CS. On the one hand, according to the present embodiment, because only the CS is notified, in the same manner as in the LTE in the related art, multiplexing by the same CS with a different mobile station is not assumed. To be more precise, the CS is allocated by the same algorithm as in the related art and it is possible to perform the demultiplexing by the CS at the receiving side. However, in a case where the CS adjacent to the format 2a is allocated, because the demultiplexing by the OCC is not possible, with regard to the CS of the format 2a, the orthogonality can be improved by allocating the remote CS.

In this manner, according to the present embodiment, an OCC can be newly introduced without increasing the notification information. As a result, the orthogonality of the DMRS between the mobile station devices 500a can be improved. The improvement of the orthogonality of the DMRS leads to the betterment of the BER performance due to the channel estimation precision due to the DMRS, and many more mobile stations can be accommodated within the same resource than in the related art. Because a PUSCH band is not insufficient, cell throughput can increase by multiplexing the control signals for many of the mobile stations into the same resource.

Furthermore, some of the functions or all of the functions of the mobile station devices 100, 100a, 200, 200a, and 500a and the base station device 300 according to each of the embodiments described above may be realized as an LSI that is a typical integrated circuit. Each functional block of the mobile station devices 100, 100a, 200, 200a, and 500a and the base station device 300 may be individually realized in a chip, and some of, or all of the functional blocks may be integrated in a chip. Furthermore, a technique of the integrated circuit is not limited to the LSI, and an integrated circuit for the functional block may be realized with a dedicated circuit or a general-purpose processor. The integrated circuit may be either hybrid or monolithic. Furthermore, some portions may be realized in hardware and some portions may be realized in software in terms of functions. Furthermore, if with advances in semiconductor technology, a circuit integration technology and the like which substitute for the LSI appear, it is also possible to use an integrated circuit to which such a technology is applied.

Furthermore, a program for realizing functions of, or a function of one portion of, each unit of the mobile station devices 100, 100a, 200, 200a, and 500a and the base station device 300 according to each of the embodiments described above may be recorded on a computer-readable recording medium, a computer system may be caused to read and run the program recoded on the recording medium, and thus each unit may be realized. Moreover, the “computer system” here is defined as including an OS and hardware components such as a peripheral device.

Furthermore, the “computer-readable recording medium” refers to a portable medium such as a flexible disk, a magneto-optical disk, a ROM, and a CD-ROM, and a storage device such as a hard disk that is built into the computer system. Moreover, the “computer-readable recording medium” is defined as including whatever dynamically includes the program for a short period of time, such as a communication line that is used when transmitting the program over a network such as the Internet or over a communication circuit such as a telephone circuit and as including whatever retains the program for a given period of time, such as a volatile memory within the computer system, which functions as a server or a client in the case of including the program dynamically. Furthermore, the program may be one for realizing some of the functions described above and additionally may be one that can realize the functions described above in combination with a program that is already recorded on the computer system.

The embodiments of the invention are described in detail above referring to the drawings, but the specific configuration is not limited to the embodiments and includes an amendment to a design that falls within a scope not departing from the gist of the present invention.

### INDUSTRIAL APPLICABILITY

The present invention can be used in a mobile communication system in which a portable telephone device is set to be a mobile station device, but is not limited to this.

### REFERENCE SIGNS LIST

10 WIRELESS COMMUNICATION SYSTEM
100, 100a, 200, 500, 500a MOBILE STATION DEVICE
101 MODULATION UNIT
102 FREQUENCY SPREAD UNIT
103 CONTROL-INFORMATION TIME SPREAD UNIT
104 DMRS TIME SPREAD UNIT
105 FRAME STRUCTURE UNIT
106 PHASE ROTATION UNIT
107 OFDM SIGNAL GENERATION UNIT
108 TRANSMIT ANTENNA
109 RECEIVE ANTENNA
110, 110a CONTROL INFORMATION RECEPTION UNIT
111 CS SEQUENCE GENERATION UNIT
112, 112a DMRS OCC GENERATION UNIT
113 CONTROL-INFORMATION OCC GENERATION UNIT
171 IFFT UNIT
172 CP ADDITION UNIT
173 D/A CONVERSION UNIT
174 ANALOG TRANSMISSION PROCESSING UNIT
300 BASE STATION DEVICE
301-1 TO 301-Nᵣ RECEIVE ANTENNA
302-1 TO 302-Nᵣ OFDM SIGNAL RECEPTION UNIT
303-1 TO 303-Nᵣ DMRS DEMULTIPLEXING UNIT
304 CHANNEL ESTIMATION UNIT
305 WEIGHT GENERATION UNIT
306-1 TO 306-Nᵣ TIME DESPREAD UNIT
307 EQUALIZATION UNIT
308 DEMODULATION UNIT
310-1 TO 310-U MOBILE STATION SIGNAL PROCESSING UNIT
321 ANALOG RECEPTION PROCESSING UNIT
322 A/D CONVERSION UNIT
323 CP REMOVAL UNIT
324 FFT UNIT
501 ERROR CORRECTION CODING UNIT
502 MODULATION UNIT
503 FREQUENCY SPREAD UNIT
504 DMRS TIME SPREAD UNIT
505 FRAME STRUCTURE UNIT
506 OFDM SIGNAL GENERATION UNIT
507 TRANSMIT ANTENNA
508 RECEIVE ANTENNA
509, 509a CONTROL-INFORMATION RECEPTION UNIT
510 CS SEQUENCE GENERATION UNIT
511, 511a DMRS OCC GENERATION UNIT

1. A mobile station device,
wherein, in a PUCCH in LTE Release 8, a reference signal that is spread using a spread code that has an orthogonal relationship with a spread code is arranged in a first domain in which a data signal that is spread by the spread code is arranged.

2. The mobile station device according to claim 1,
wherein, in the PUCCH in LTE Release 8, the data signal is arranged in a second domain in which a demodulation reference signal for the data signal is arranged.

3. The mobile station device according to claim 2,
wherein the data signal that is arranged in the second domain is spread using the spread code, and
wherein the spread code that is used in the case where the data signal which is arranged in the second domain is spread has the orthogonal relationship with the spread code that is used in the case where the demodulation reference signal is time-spread.

4. The mobile station device according to claim 1,
wherein, in the PUCCH in LTE Release 8, the spread codes of which the number is greater than the number of codes that are selectable as the spread code that spreads the data signal are selectable as a code that spreads the reference signal.

5. The mobile station device according to claim 4,
wherein, in the PUCCH in LTE Release 8, the spread code that is used in the time spread of the reference signal is selected using a value that designates a spread code which is used in frequency spread, and a value that designates a spread code that is used in time spread.

6. A communication method comprising:
a first step of spreading a reference signal using a spread code that has an orthogonal relationship with a spread code that spreads a data signal in a PUCCH in LTE Release 8; and
a second step of arranging the reference signal being spread in a first domain in which the data signal is arranged.
